(19) United States
(12) Patent Application Publication
(10) Pub. No.: US 2026/0299295 A1
(43) Pub. Date: Oct. 1, 2026

(54) HANDLING OF SECURITY EVENT OF A PERSONAL DEVICE IN COLLABORATION WITH A VIRTUAL REALITY HEADSET

(71) Applicant: Orange, Issy-Les-Moulineaux (FR)

(72) Inventors: Zhihong GUO, Beijing (CN); Liang HAN, Beijing (CN)

(21) Appl. No.: 19/489,372

(22) PCT Filed: May 17, 2024
(86) PCT No.: PCT/EP2024/063654

§ 371 Date: Dec. 2, 2025

(30) Foreign Application Priority Data
Jun. 2, 2023 (WO) PCT/CN2023/098063

(51) Int. Cl. G02B 27/01; G06F 3/01; G06F 21/32; G06Q 20/32; G06Q 20/40

(52) U.S. Cl. CPC G02B 27/017; G06F 3/013; G06F 21/32; G06Q 20/321; G06Q 20/322; G06Q 20/40145

(57) ABSTRACT

A method for handling a security event of a personal device in collaboration with a virtual reality headset, this method including: capturing a security event raised on the personal device and transmitting a security message, related to the security event, to the virtual reality headset; and handling the security message at the virtual reality headset by switching the virtual reality headset to a passthrough mode.

### CROSS-REFERENCE TO RELATED APPLICATIONS

This application is filed under 35 U.S.C. § 371 as the U.S. National Phase of Application No. PCT/EP2024/063654 entitled “HANDLING OF SECURITY EVENT OF A PERSONAL DEVICE IN COLLABORATION WITH A VIRTUAL REALITY HEADSET” and filed May 17, 2024, and which claims priority to PCT/CN2023/098063 filed Jun. 2, 2023, each of which is incorporated by reference in its entirety.

### BACKGROUND

### Field

The development relates to the interaction of a user with a personal device while wearing a virtual reality headset.

In particular, it applies to the handling of security events at the time the user wears a virtual reality headset.

### Description of the Related Technology

A virtual reality headset (or VR headset) is a head-mounted device that provides virtual reality for the wearer. VR headsets are widely used with VR video games but they are also used in other applications, including simulators and trainers, and other industrial fields are regularly addressed (surgery, etc.).

While wearing a VR headset, the user has limited possibilities to interact with the real world (by opposition to the virtual reality displayed through the VR headset), and in particular with digital devices like a personal device (e.g. smartphone, digital tablet, desktop or laptop computer, etc.).

When an event, in particular a security event, is raised at his personal device, its user wearing a VR headset may not be easily capable to properly handle it.

Handling such event may require looking at the personal device. Some VR headsets are equipped with front-facing cameras allowing the user to look at his/her environment in front of him/her without taking out the headset.

However, such arrangement may not be convenient enough in certain circumstances. In particular, the user may not be aware that a security event has occurred at its personal device. In certain cases, not reacting fast enough may result in negative effect, like for instance a transaction being aborted. Also, if the user expects such a security event to happen (because he has placed an online purchase, for instance), he may not know exactly when it will happen and may need to remove his VR headset too early, which downgrade dramatically his VR experience.

More generally, the uncertainty of the time at which a security event may occur jeopardizes an immersive experience in the virtual reality world, as the user is required to timely check for its occurrence and/or may miss it.

In addition, such functionality may not be sufficient or acceptable in case of security event. Security events comprise a prompt for unlocking the screen and Human-Machine Interface of the personal device, or a prompt for authorizing a sensible action like e.g. a payment.

Usually, such prompts aim for biometric authentication. For example, it is usual to allow the unlocking of a personal device or the authorization of a sensible action only after the visual recognition of the user: a photo of the user's face is taken by the embedded camera of the personal device and the photo is then compared with stored photos so as to determine whether the current user is the registered user of the personal device or not.

Clearly, in order for such a comparison to be positive, the user's face shall be visible and recognizable on the taken photograph, which is impossible if the user wears the VR headset.

So, according to today's technologies, the user would be required to remove the VR headset in order to handle the security event raised on his/her personal device.

This appears to be a major inconvenient for the users since this requires them to interrupt their experience with the VR headset. In particular, when the security event is linked with this experience, removing the VR headset is harmful for his/her overall experience.

There is therefore a strong need to improve the existing methods for handling security events of a personal device, while the user wears a VR headset.

### SUMMARY

An object of the present development aims in alleviating at least partly the above-mentioned drawbacks.

This object is achieved with a method for handling a security event of a personal device in collaboration with a virtual reality headset, the method comprising:
capturing a security event raised on said personal device and transmitting a security message, related to said security event, to said virtual reality headset;
handling said security message at said virtual reality headset by switching said virtual reality headset to a passthrough mode.

Such a method allows to switch to passthrough mode at the optimal moment, i.e. when the security event just occurred. This avoids any security event to be missed and the user being required to timely check for any security event to occur on his/her personal device. The switching to passthrough mode is then limited to a minimum amount of time, increasing the VR experience, while guaranteeing the handling of all security event.

Preferred embodiments comprise one or more of the following features, which can be taken separately or together, either in partial combination or in full combination.
handling said security message at said virtual reality headset comprises taking at least one iris photograph and authenticating a user from said at least one iris photograph when receiving said security message, said virtual reality headset switches to a passthrough mode;
switching to said passthrough mode comprises switching on a front-facing camera of said virtual reality headset;
said security event relates to a payment triggered at said virtual reality headset;
said capturing comprises handling said security event at a security service embedded within said personal device;
authenticating a user from said at least one iris photograph is based on stored authentication information;
said stored authentication information comprises a stored iris photograph and comparing said at least one iris photograph with said stored iris photograph;
once said security message is handled at said virtual reality headset, said virtual reality headset switches from said passthrough mode to a normal mode;

Another object relates to a virtual reality headset comprising an interface configured for receiving a security message from a personal device, and a processor adapted for handling said security message by switching said virtual reality headset to a passthrough mode.

Preferred embodiments comprise one or more of the following features, which can be taken separately or together, either in partial combination or in full combination.
said processor (13) is further adapted for handling said security message by triggering at least one eye tracking camera (15a, 15b) adapted to take at least one iris photograph of a user of said virtual reality headset (VRH) and triggering an authentication of said user from at least one iris photography
said processor is further adapted to trigger a transmission, through said interface, of a security response to said personal device according to said authentication.
the virtual reality headset is further adapted for, when switching to said passthrough mode, switching on a front-facing camera of said virtual reality headset?

Another object relates to a personal device comprising a processor adapted for capturing a security event and instructing an interface to transmit a security message related to said security event to a virtual reality headset.

Preferred embodiments comprise one or more of the following features, which can be taken separately or together, either in partial combination or in full combination.
said processor is adapted for deploying a security service in charge of capturing said security event and instructing said interface.
said security service is adapted to authorize said security event according to a security response received from said virtual reality headset.
Another object relates to a system comprising a virtual reality headset as previously defined and a personal device as previously defined.

Another object relates to a computer program comprising code instructions for executing a method as previously defined.

Further features and advantages of the development will appear from the following description of embodiments of the development, given as non-limiting examples, with reference to the accompanying drawings listed hereunder.

### BRIEF DESCRIPTION OF THE DRAWINGS

FIG. 1 illustrates a chronogram according to embodiments of the proposed method.

FIG. 2 illustrates an example virtual reality headset according to embodiments.

FIG. 3 illustrates an example personal device according to embodiments.

### DETAILED DESCRIPTION OF CERTAIN ILLUSTRATIVE EMBODIMENTS

The proposed method aims in improving the interworking between a personal device and a virtual reality headset, and in particular in handling security events of a personal device in collaboration with a virtual reality headset.

Personal device may be any digital device that may be used by an individual and uses personal data and/or shall be protected by security means. In particular, this encompasses devices that may trigger security events like prompting for personal authentication, e.g. biometric authentication (face recognition, etc.).

A wide diversity of personal devices may thus be encompassed within such definition and be addressed by the proposed method.

Examples of personal devices are mobile telecommunication units (mobile phones, smartphones . . . ) , digital tablets, desktop or laptop computers, smartwatches, etc.

The personal device is either used by a single user (mobile phone . . . ) or shared among a group of users, each of them having a personal account (computer . . . ). At a given time, however, this shared device can be considered as a personal device.

The virtual reality headset can be shared with several account.

VR headsets are a rather new technology on the market, but they are already a number of VR headsets available with a diversity of hardware and software features.

The dedicated Wikipedia page may provide some further information about virtual reality headsets and available models:
https://en.wikipedia.org/wiki/virtual_reality_headset

Generally speaking, a VR headset implies its user to be (at least) visually isolated from the environment. Accordingly, the headset covers his/her eyes to show him/her a virtual environment.

Some VR headsets however provides some see-through or passthrough functionality, which consists in physically allowing the user to see the environment in front of him/her with his/her own eyes. Temporarily, the virtual environment may then be not shown and replaced by the real environment as, for example, captured by a front camera. Some VR headsets may also propose as a functionality to show a mixed environment constituted by both the real world and the virtual world.

The passthrough mode is useful when the user wishes to interact with the real world while wearing the VR headset. In case the interaction is only temporary, he or she may not want to remove the VR headset: this would be a lack of time, and an interruption of the immersive experience provided by the virtual reality.

In particular, the user wearing a VR headset may need to handle a security event on his/her personal device.

The security event may be linked or not to the behavior of the user with the VR headset.

For instance, the security event may be linked to a notification triggered at the personal device: incoming SMS/MMS message or e-mail, notification from an application, etc.

A possible situation where the security event is linked to the behavior of the user with the VR headset may concern a payment. For instance, the user may want to purchase a game or an application while using the VR headset, or may want to buy some tokens or other internal money within a VR application. In such situation, it is usual that the purchase requires an action through his/her personal device (use of a dedicated application, reception of a single-use pin code, etc.).

An example of a payment application for virtual reality environments is the Pico VR Mobile application.

In general, the personal device is locked for security reason, and the notification triggers then a security event comprising a prompt for unlocking the personal device.

Unlocking the mobile device is generally made by biometric means, for example through facial recognition. Passwords or pin codes may also be used.

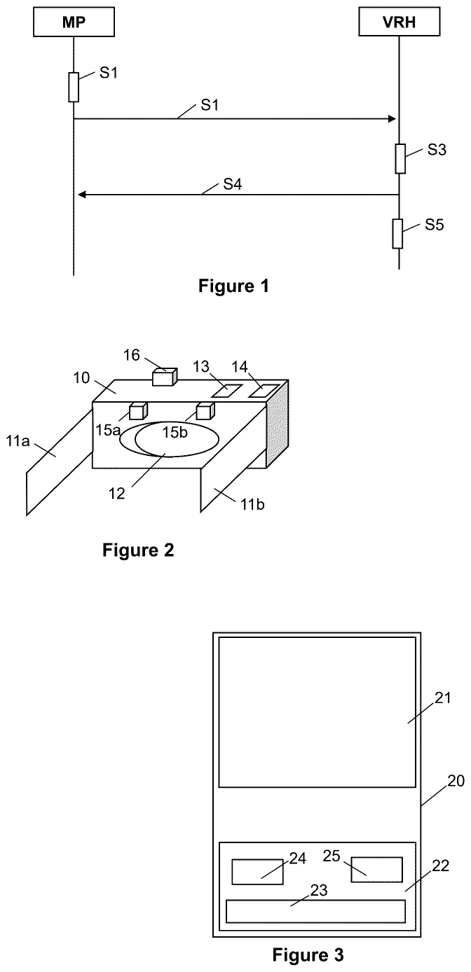

FIG. 1 depicts a chronogram showing possible interactions between a personal device, MP, and a virtual reality headset, VRH.

At step S1, a security event raised on the personal device MP is captured. The security event may be captured by a security service running on the personal device.

FIG. 3 depicts an example of high-level functional architecture of a possible personal device MP.

The personal device may comprise a housing 20, a screen 20 (and other Human-Machine Interface elements, not depicted) and a software part, 22, that may be deployed on an infrastructure comprising a least one processor, a memory and, potentially, other circuitries.

The software part 22 may comprise an operating system (OS), 23, a security service 24 and, possibly, one or several applications, 25. The security service 24 may for instance be part of the operating system (OS), or of a middleware sitting between the OS and the applications. Several embodiments are possible on this matter.

An application 25 deployed on the personal device may trigger a security event on the security service 24. The application may be a SMS/MMS application, a Social Network application, a payment application, etc. The triggering may be direct or indirect through the Operating system for instance: an application will simply raise a notification and, as the personal device is locked, the security service is switched to the frontend to allow the user to unlock it. The security service 24 is then in charge of handing the security event.

This capture step S1 may be considered as overriding the usual behavior: instead of using local facilities for handling the security event (e.g. prompting for facial recognition, entering a pin code, etc.), a security message is transmitted, in step S2, to the virtual reality headset, VRH.

This security message is related to the security event. In particular, its content may depend on details of the security event. At least, the security message shall identify itself as being related to a security event, so that the recipient can automatically determine what actions on its side should be triggered.

The transmission of the security message between the personal device and the VP headset may be performed according to available communication means. In particular, short-range radio communication technologies (like Bluetooth, Wi-Fi Direct, etc.) may be used. The personal device and the VP headset may have been previously paired.

At step S3, the security message is received and handled at the virtual reality headset, VRH.

When the security message is received, the virtual reality headset VRH switches to a passthrough mode. This would enable the user to become aware of the received security event and to handle the security event at his/her personal device.

Furthermore, according to embodiments, the virtual reality headset may take at least one iris photograph of its user. This iris photograph can be used as biometric means for identifying and authenticating the user and may thus replace the biometric authentication initially intended to be placed at the personal device, MP. In other words, the biometric authentication is deported from the personal device to the virtual reality headset.

FIG. 2 depicts an example of high-level functional architecture of a possible virtual reality headset VRH, which may be used for some embodiments of the proposed method.

A virtual reality headset may comprise a housing 10 and means 11a, 11b, to secure the headset on the user's head, so that his/her eyes are located in front of dedicated emplacement 12. The emplacement may be a light-emitting device, like a screen, aiming in showing images to the user.

The virtual reality headset comprises an interface 14 configured for receiving the security message from the personal device (MP). This interface complies with the communication technology used for having the virtual reality headset and the personal device interworking (as mentioned above, examples may be Bluetooth, Wi-Fi Direct, etc.).

The virtual reality headset comprises also a processor 13 (and, possibly, associated circuits and memory means) configured for handling the security message. The processor 13 may be in charge of triggering at least one eye-tracking camera 15a, 15b adapted to take at least one iris photograph of the user of the virtual reality headset VRH.

Only one photograph may be taken, or a couple of photographs, each for each eye. Also, several photographs may be taken at short intervals.

As known in the art, the eye-tracking camera(s) 15a, 15b may take iris photographs of the user thanks to hot mirrors that direct part of the light coming from the eyes to the cameras, along a different axis than the axis of the eyes towards the screen 12.

Such an arrangement is for instance described in patent U.S. Pat. No. 10,877,556B2, but other arrangements may also be possible and accessible to the skilled person.

The processor 13 is also in charge of authenticating the user (of both the personal device and of the VR headset) from the taken iris photograph(s).

In particular, this authentication may be based on the information related to this or these iris photographs, which may be the photographs themselves, or data derived from these photographs. For instance, image features may be extracted from the iris photographs, or a processed image can be elaborated from a set of iris photographs, etc.

The information related to the iris photographs may be confronted with stored authentication information associated with the user.

The authentication information serves as a model that can be used to authenticate the user from the taken iris photograph(s), i.e. to determine whether the user that is currently using the VP headset is the same who had initially registered, and is thus entitled to use the personal device.

The stored authentication information may an initial and stored iris photograph that has been taken previously when the user registered (for example to the security service), in a same way than a facial recognition feature or any other authentication feature.

In such a case, the authentication of the user may simply consist in a comparison of the at least one iris photograph with this stored iris photograph.

The stored authentication information may also be image features extracted from the initial iris photograph. In such a case, similarly, the authentication may consist in comparing these image features with image features extracted from the taken iris photograph(s).

The stored authentication information may also be a model elaborated from several iris photographs taken for a same user, at registration time. This model would be more robust and provide better quality in the authentication of the user.

The comparison between a taken iris photograph and a stored iris photograph, or between image features extracted from the same, can be made by conventional technologies of the field.

Also, the authentication can also be based on machine learning or artificial intelligence technologies.

For example, then, a model can be trained on several iris photographs (or image features extracted from these iris photographs) and then used to predict whether a new iris photograph taken for a user matches this model and can then authenticate the user.

One can mention as possible artificial intelligence technologies those described in patents CN104484588B or in the article “IRIS Recognition Using Neural Network” of Leila Fallah Araghi, Hamed Shahhosseini, Farbod Setoudeh in Proceedings of the International MultiConference of Engineers and Computer Scientists 2010, vol. 1, IMECS 2010.

Many more references are available to the skilled person, as well as many other techniques. The proposed method is independent on how exactly the iris photograph(s) is/are used for authenticating the user.

The authentication information may be stored, individually or not, in a raw format or as a model (or template), e.g. for machine learning. The storage may be in various locations including the VR headset VRH itself, in a remote place accessible via a telecommunication network.

According to embodiments, the authentication step may be performed remotely. The authentication information may then be stored in a remote apparatus, and the iris photograph(s) taken by the VR headset may then be transmitted to this remote apparatus, where the authentication can take place. Then the result of this authentication may be transmitted back to the VR headset.

According to embodiments, this remote apparatus may be a remote server.

According to embodiments, this remote apparatus may be the personal device MP. More precisely, this remote apparatus may be the security service 24 of the personal device.

In such a situation, the authentication information may be initially captured by the personal device and stored either locally or in a remote place (remote server, cloud . . . ). Also, personal device can then handle the security event locally, based on this authentication.

Also, when receiving the security message, the virtual reality headset VRH switches to a passthrough mode. In passthrough mode, the user can see what is in front of him/her as if not wearing any headset and as previously explained.

Switching to a passthrough mode may comprise switching on a front-facing camera 16 embedded on the virtual reality headset, VRH.

Then, at the time the personal device will be unlocked, the user can look at the personal device's screen and see and read any notification(s) which have triggered the security event.

In addition, the Virtual reality headset, VRH, may determine to pause the VR application currently running on the VR headset. While in passthrough mode, the user may not be able to visualize the virtual reality environment, so that it may be preferable to temporarily stop the application. The user can resume the application when he/she has finished to handle the notification raised at the personal device, MP.

According to embodiments, at step S4, once the comparison performed, a security response may be transmitted, through the interface 14, to the personal device, MP. This step S4 is required only in embodiments where the personal device MP has not performed the authentication step itself.

In step S5, the security event is handled based on the authentication performed at step S3.

This handling can be based on the security response received from the virtual reality headset in situation where the authentication is performed at the VR headset. This security response can be interpreted by the personal device as would be the result of an authentication process performed locally.

In particular, according to embodiments, the security service is adapted to authorize the security event according to the authentication (e.g. based on this security response received from said virtual reality headset, VRH).

The security service can then handle this security reply to proceed according to state-of-the-art behaviors:
if the user is authenticated: unlocking the personal device, or:
if the user is not authenticated: denying the unlocking of the personal device, prompting the user in a different way (e.g. pin code), etc.

As explained above, the security event raised at the personal device is then deported, at least partly, to the VP headset, while keeping the same level of biometric security.

Thanks to this collaboration, the security event can be addressed without the user required to remove the VP headset. Even, the security event may be addressed without the user required to manipulate the personal device (even this may be needed, in a later step, to address the notification that has raised the security event).

According to embodiments, once the security message is handled at the virtual reality headset, the VR headset may be switched from passthrough mode to normal mode, for instance automatically. This can be done for instance, once the comparison is performed (i.e. at the end of step S4) since at this step the final steps are undertaken by the personal device without, in certain embodiments, the user to intervene.

According to embodiments, the switching back to normal mode may occur at receipt of a message. This message may indicate that the security event has been handled based on the authentication. This message may indicate that the authentication is validated, so that the user may not need to intervene anymore. Accordingly, the VR headset may not be required to be kept in passthrough mode and may revert to normal mode.

According to embodiments, this message may be transmitted from the personal device, MP, or from a remote server, as envisioned previously, which may be in charge of the authentication steps.

Other options are of course possible regarding the time at which the VR headset switches back to normal mode.

According to further embodiments, a user action may be needed for this switch back to occur.

The development has been described with reference to preferred embodiments. However, many variations are possible within the scope of the development.

1. A method of handling a security event of a personal device in collaboration with a virtual reality headset, the method comprising:
capturing a security event raised on the personal device and transmitting a security message, related to the security event, to the virtual reality headset; and
handling the security message at the virtual reality headset by switching the virtual reality headset to a passthrough mode.

2. The method according to claim 1, wherein handling the security message at the virtual reality headset comprises taking at least one iris photograph and authenticating a user from the at least one iris photograph.

3. The method according to claim 1, wherein switching to the passthrough mode comprises switching on a front-facing camera of the virtual reality headset.

4. The method according to claim 1, wherein the security event relates to a payment triggered at the virtual reality headset.

5. The method according to claim 1, wherein the capturing comprises handling the security event at a security service embedded within the personal device.

6. The method according to claim 1, wherein, once the security message is handled at the virtual reality headset, the virtual reality headset switches from the passthrough mode to a normal mode.

7. A virtual reality headset comprising an interface configured for receiving a security message from a personal device, and a processor adapted for handling the security message by switching the virtual reality headset to a passthrough mode.

8. The virtual reality headset according to claim 7, wherein the processor is further adapted for handling the security message by triggering at least one eye tracking camera adapted to take at least one iris photograph of a user of the virtual reality headset and triggering an authentication of the user from at least one iris photography.

9. The virtual reality headset according to claim 8, wherein the processor is further adapted to trigger a transmission, through the interface, of a security response to the personal device according to the authentication.

10. The virtual reality headset according to claim 7, further adapted for, when switching to the passthrough mode, switching on a front-facing camera of the virtual reality headset.

11. A personal device comprising a processor adapted for capturing a security event and instructing an interface to transmit a security message related to the security event to a virtual reality headset.

12. The personal device according to claim 11, wherein the processor is adapted for deploying a security service in charge of capturing the security event and instructing the interface.

13. The personal device according to claim 12, wherein the security service is adapted to authorize the security event according to a security response received from the virtual reality headset.

14. A system comprising a virtual reality headset according to claim 7 and a personal device comprising a processor adapted for capturing a security event and instructing an interface to transmit a security message related to the security event to a virtual reality headset.

15. A non-transitory storage medium comprising program code instructions for executing the method according to claim 1.
